(19) United States
(12) Patent Application Publication
(10) Pub. No.: US 2010/0119662 A1
(43) Pub. Date: May 13, 2010

(54) Two Phase Beverage Comprising Encapsulated Fruit Pulp

(75) Inventors: Peter Horlacher, Bellenberg (DE); Bernd Jenzer, Balzheim (DE); Katja Beck, Bellenberg (DE); Celine Boulat, Saint Cheron (FR); Catherine Gerard, Nozay (FR); Baya Hannoucene, L'Hay-Les-Roses (FR); Laurent Schmitt, Igny (FR)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/524,461

(22) PCT Filed: Dec. 8, 2007
(86) PCT No.: PCT/EP07/10716

§ 371 Date: Jul. 24, 2009

(30) Foreign Application Priority Data
Jan. 25, 2007 (EP) EP07001592

(51) Int. Cl. A23P 1/04; A23L 1/05; A23L 1/072; A23L 1/212; A23L 2/02

(52) U.S. Cl. 426/102; 426/506; 426/590

(57) ABSTRACT

The present invention relates to a two phase beverage comprising an aqueous phase and encapsulated fruit pulp.

The present invention relates to a two phase beverage comprising an aqueous phase and encapsulated fruit pulp.

A two phase beverage according to the present invention is a dispersion of encapsulated fruit pulp in an aqueous liquid. The density of the encapsulated fruit pulp is higher than the density of the aqueous liquid so that the encapsulated fruit pulp settles at the bottom of the two phase beverage if the beverage is not shaken or stirred. It is desirable that a sharp phase interface can be achieved between lower layer (encapsulated fruit pulp together with as much aqueous liquid as is needed to fill the space between the particles of encapsulated fruit pulp) and the upper layer (aqueous liquid). It shall be possible to have a clear transparent upper layer if the aqueous liquid itself is clear and transparent.

GB-A 1 302 275 discloses fruit pulp or puree encapsulated in a skin of calcium alginate (page 1, lines 19 to 22). Furthermore this document discloses a method for making this encapsulated fruit pulp by incorporating calcium ions into the fruit pulp and bringing drops of the fruit pulp comprising the calcium ions into contact with an alginate sol (page 1, lines 27 to 33 and page 2, lines 43 to 89). Because the resulting capsules may be sticky their surface may be treated with calcium ions (page 1, lines 52 to 61). The encapsulated fruit pulp may be incorporated into yoghurt, pie filling or jam (page 2, lines 98 to 99). The capsules obtained resemble blackcurrants (page 3, examples 1 and 2).

EP-A 1629 722 discloses a pourable composition comprising gelled beads dispersed in a continuous aqueous phase. The beads have an average diameter of 1 to 15 mm and contain alginate gelled with divalent metal ions, fruit flavouring, fruit material, sugar and water. The beads are made by introducing an aqueous liquid containing alginate into a gelling liquid containing divalent metal ions, said aqueous liquid may be dripped into said, continuously stirred, gelling liquid (paragraph 41). The pourable composition may be used as an ingredient in the manufacture of a beverage (paragraph 28).

U.S. Pat. No. 4,276,312 discloses a method for preparing an encapsulated product comprising spray drying a dispersion of encapsulating material such as modified starch and active material such as imitation flavors.

CN-A 1 545 946, according to the abstract published by Derwent Publications Ltd., abstract no. 2005-164119, discloses a concentrated fruit juice soft capsule. No details are disclosed.

U.S. Pat. No. 4,507,327 discloses a process for making capsules by dropping a liquid containing sugar and a calcium salt into an alginic acid salt liquid.

JP-A 58 205 463, according to the corresponding English patent abstract of Japan, discloses a beverage containing granules. The granules are made of calcium alginate and are filled with fruit juice or water. The granules are made by adding a fruit juice containing a calcium salt to an aqueous alginate salt solution.

None of the documents of the state of the art discloses a two phase beverage with the previously described properties. The capsules disclosed by the state of the art are spherical beads. The fibre like texture of the fruit pulp is lost during encapsulation. This may be regarded as a disadvantage by consumers of a two phase beverage who do not expect “sterile” spherical capsules in a beverage but who expect organoleptic properties resembling those of real fruit pulp dispersed in water. Furthermore consumers might associate spherical capsules with fish spawn and therefore dislike a two phase beverage based on spherical capsules.

The problem underlying the present invention is to provide a two phase beverage with the previously described advantageous properties. The disadvantages of the state of the art shall be overcome. Furthermore the problem is to provide encapsulated fruit pulp that allows making a two phase beverage according to the present invention.

This problem is solved by encapsulated fruit pulp obtainable according to any of the following methods and by a two phase beverage containing this encapsulated fruit pulp:

A method for producing encapsulated fruit pulp, comprising
a) contacting of the fruit pulp with an encapsulating agent, particularly a carbohydrate, more particularly an alginate,
b) mixing (particularly by stirring) of the fruit pulp and the encapsulating agent, thus obtaining a mixture, and
c) adding of this mixture to an aqueous solution, which activates capsule formation (in case the encapsulating agent is an alginate, this solution is an aqueous solution of a divalent metal salt, preferably a calcium salt, e.g. calcium chloride) so that encapsulation occurs,
wherein during encapsulation shear energy is introduced into the aqueous solution in such an amount that the resulting encapsulated fruit pulp does not consist of spherical capsules (often referred to as beads) but keeps a fibre like texture similar to the texture of the fruit pulp itself.

A method for producing encapsulated fruit pulp, comprising
contacting of the fruit pulp with an encapsulating agent, particularly a carbohydrate, more particularly an alginate,
mixing of the fruit pulp and the encapsulating agent, thus obtaining a mixture, and
adding of this mixture to an aqueous solution, which activates capsule formation so that encapsulation occurs,
   wherein during encapsulation shear energy is introduced into the aqueous solution in such an amount that the resulting encapsulated fruit pulp does not consist of spherical capsules but has an average length to breadth ratio of more than 1.2.

The method according to the present invention, characterized in that the alginate is sodium alginate.

The method according to the present invention, characterized in that the fruit pulp is orange pulp, black currant pulp, pear pulp, mango pulp, kiwi pulp or peach pulp.

The method according to the present invention, characterized in that the capsules of the encapsulated fruit pulp have an average diameter (determined by laser diffraction) d50 of less than 2 mm, with d50 being the percentile value, in which 50% of the capsules have a smaller diameter than the stated one.

These methods and the encapsulated fruit pulp obtainable according to any of these methods are subjects of the present invention.

Preferably the encapsulated fruit pulp obtainable according to any of said methods has an average length to breadth ratio of more than 1.2 (preferably more than 1.5; preferably more than 1.8; preferably more than 2). The length to breadth ratio is defined in the following way. The particles of the encapsulated fruit pulp have a fibre like texture similar to the texture of non-encapsulated fruit pulp, i.e. the particles are not spherical but are elongated along one axis. The average length to breadth ratio is the average ratio between the longer axis and the shorter axis of the particles. The average is a number average that may be obtained by optical investigation of the particles (e.g. using a microscope).

Furthermore the following subjects are subjects of the present invention:
The use of the encapsulated fruit pulp according to the present invention for the production of compositions containing the encapsulated fruit pulp and a liquid, particularly for the production of beverages.
A composition comprising the encapsulated fruit pulp according to the present invention and a liquid (particularly water).
Said composition further comprising a flavouring substance.
The composition according to the present invention, characterized in that this composition is a two phase beverage.
The two phase beverage according to according to the present invention, wherein the pH of this beverage is higher than 4.

According to the present invention the fruit pulp keeps its fibre like texture after encapsulation. In order to achieve this it is essential that shear forces are applied during the encapsulation process. Adequate shear forces may be applied by milling or by using high speed stirrers.

In order to obtain the required structuring properties, encapsulation has to be carried out in the presence of shear forces as generated, for example, by rotor/stator systems, such as toothed colloid mills, Ultra-Turrax, etc. Alternatively, for technical reasons, the components to be encapsulated may also be added just before such systems. In addition, the particle size and hence the stability of the dispersion (sedimenting behavior) is influenced by adjustment of the gap in toothed colloid mills.

One surprising advantage of the encapsulated fruit pulp is that, although the particles of the fruit pulp are non-spherical and although shear forces during encapsulation have to be applied in order to obtain such non-spherical particles, the capsules are stable and do not disintegrate when dispersed into an aqueous phase to obtain a two phase beverage. Furthermore the two phase beverage obtained has a sharp phase interface between lower layer (encapsulated fruit pulp together with as much aqueous liquid as is needed to fill the space between the particles of encapsulated fruit pulp) and the upper layer (aqueous liquid). It has a clear transparent upper layer if the aqueous liquid itself is clear and transparent. I.e. the encapsulated fruit pulp does not contain significant amounts of non-encapsulated fruit pulp or of extremely small particles that do not settle and thus render the phase interface unclear and the upper phase intransparent. This is surprising because one could assume that the shear forces applied during encapsulation lead to exactly these disadvantages.

Settling time of the encapsulated fruit pulp in the two phase beverage may be adjusted by adjusting the amount of shear energy introduced during encapsulation.

The term fruit pulp includes, but is not limited to, fruit concentrate, fruit paste and fruit puree. The encapsulated fruit pulp according to the present invention consists of particles. These particles are called capsules, or capsules containing fruit pulp.

If an alginate is used as encapsulating agent then this alginate can be exposed to the fruit pulp (particularly be added to it), both in solid or dissolved state (e.g., in water).

The term alginate either means pure alginate that is not mixed with other encapsulating agents or it means a mixture of alginate with for example other carbohydrates such as derivatives of cellulose such as hydroxypropylmethyl cellulose or starch derivatives such as modified starches or gums such as tara gum or other carbohydrates from algae such as carrageenan etc.

The capsules can, after their production, be washed, filtrated, and packaged aseptically.

The preferred use of the capsules according to the invention is their addition to beverages. A two-phase beverage is thus obtained. By shaking, the lower phase (the capsules containing fruit pulp) can be dispersed homogeneously. The composition separates when left standing. Separation behaviour depends, inter alia, on the amount of alginate (in case the capsules contain alginate), and capsule size distribution. Furthermore, separation behaviour also depends on the concentration of encapsulated fruit pulp in the composition. Flavouring substances can be added to the water phase of the two-phase beverage thus obtained.

The capsules according to the invention possess high shear stability. They show stability with regard to the shearing which occurs in a high shear mixer, e.g. of the Turrax brand. They are stable with regard to the shearing which occurs in the standard toothed colloid mills, e.g. in the so-called Fryma mill (a mill made by the company FrymaKoruma GmbH, 79395. Neuenburg, Germany).

The capsules can be pasteurised without loosing their preferred properties.

The beverage containing capsules according to the invention preferably comprises the following ingredients besides the capsules containing fruit puree. Preferably the main ingredient is water, for example natural mineral water.

Preferably the beverage contains an acid to improve the flavour of the product. This acid can be, for example, citric acid or ascorbic acid or lactic acid or tartaric acid or malic acid or phosphoric acid or hydrochloric acid. It is usually not necessary to add an acid if the fruit puree (e.g. citrus puree) or another ingredient conveys an acidic flavour.

Preferably in order to increase the beverage shelf life one or more preservatives are added such as, for example benzoic acid, sodium or potassium benzoates, sorbic acid, sodium or potassium sorbate.

Preferably sugars are added such as mono and disaccharides, hydrolyzed (and isomerized) starch syrups, inverted sugar.

One or more intense sweeteners can be added such as acesulfam K, sucralose, aspartame, or bulk sweeteners such as polyols.

In general the preparation of the beverage comprises a pasteurization step. The encapsulated puree can be pasteurized in water at a temperature between 62° C. and 100° C. for a time between 10 seconds to 30 minutes in a mixer, preferably a traditional agitator with 4 blades at a rotational speed from 4 to 1200 rpm. This process for pasteurization may be used on a laboratory scale. On a production scale pasteurization may be carried out in a tubular heat exchanger.

A further embodiment of the present invention is a method for suppressing the film impression when drinking a beverage according to the invention by adjusting the pH value of the beverage to a value of above 4.0 by using malic acid or above 4 with citric acid or above 4.5 with lactic acid or above 4.5 with tartaric acid or above 5 with ascorbic acid. “Film impression” may be described as fibres perceived on one's teeth after one has drunken a beverage according to the present invention.

A further embodiment of the present invention is a composition comprising the capsules according to the present invention and a liquid (particularly water), wherein the composition has a pH value of above 4.0, and wherein the composition comprises malic acid.

A further embodiment of the present invention is a composition comprising the capsules according to the present invention and a liquid (particularly water), wherein the composition has a pH value of above 4 and wherein the composition comprises citric acid.

A further embodiment of the present invention is a composition comprising the capsules according to the present invention and a liquid (particularly water), wherein the composition has a pH value of above 4.5 and wherein the composition comprises lactic acid.

A further embodiment of the present invention is a composition comprising the capsules according to the present invention and a liquid (particularly water), wherein the composition has a pH value of above 4.5 and wherein the composition comprises tartaric acid.

A further embodiment of the present invention is a composition comprising the capsules according to the present invention and a liquid (particularly water), wherein the composition has a pH value of above 5 and wherein the composition comprises ascorbic acid.

### EXAMPLES

### Example 1

3% by weight of sodium alginate were stirred into 97% by weight of mango fruit pulp, the mixture was heated to approx. 70° C. and stirred until the sodium alginate was completely dissolved. 30 g of the sodium alginate fruit paste thus received were stirred into 100 g of 10% aqueous calcium chloride solution and subsequently homogenised for 15 seconds in a high shear mixer (Ultra Turrax level 1). Filtration and rinsing with distilled water followed until the washing water was free of oxalic acid precipitation.

### Example 2

4.2 g of sodium alginate were dissolved in 100 g of water at a temperature of 40° C. This solution was added to 140 g of mango fruit pulp at 40° C. and stirred (mango fruit pulp, by Döhler. “16.1-17.1 Brix” stands for a standard method for measuring the solids content; measuring is carried out by means of a refractometer). 140 g of calcium chloride (34% aqueous solution) were circulated in a Fryma mill. The composition of sodium alginate and mango fruit pulp was directly added in small doses before the Fryma mill by means of a pump (mono pump) and continued to be circulated. Filtration and rinsing with distilled water followed until the washing water was free of oxalic acid precipitation.

### Properties of the Encapsulated Fruit Pulps According to Examples 1 and 2:

Both the encapsulated pulps according to Example 1 and Example 2 were easily separated from the aqueous phase, provided the encapsulated pulps were suspended in water.

The result of the sensory examination of the encapsulated pulp elutriated in water was that taste and flavour of the fruit pulp were completely lost due to encapsulation. The beverage showed a neutral taste.

### Example 3

### Properties of an Encapsulated Mango Fruit Pulp Produced According to Example 1 and an Encapsulated Peach Pulp Produced Accordingly

In a cylindrical container, 70% by volume of water and 30% by volume of the encapsulated fruit pulp were combined and homogenised by shaking. If the container was left standing, after a short time the solution separated into a clear upper water phase and a lower non-transparent phase, in which the capsules were dispersed. Table 1 shows the height of the lower non-transparent dispersion after 30 minutes of leaving it standing (in percent of the total liquid height).

TABLE 1
Precipitation of mango pulp capsules and peach pulp
capsules after repeated shaking as described above;

| Shaking | Mango pulp | Peach pulp |
|---|---|---|
| 1× | 27.0% | 29.4% |
| 2× | 28.2% | 32.9% |
| 3× | 29.4% | 32.9% |
| 4× | 29.4% | 34.1% |
| 5× | 28.2% | 31.8% |
| 6× | 29.4% | 32.9% |
| 7× | 29.4% | 32.9% |
| 8× | 30.6% | 34.1% |
| 9× | 28.2% | 31.8% |
| 10× | 28.2% | 34.1% |
| 11× | 28.2% | 34.1% |
| 12× | 30.6% | 32.9% |
| 13× | 27.0% | 31.8% |
| 14× | 28.2% | 31.8% |
| 15× | 30.6% | 34.1% |
| 16× | 28.2% | 34.1% |
| 17× | 28.2% | 32.9% |
| 18× | 29.4% | 32.9% |
| 19× | 29.4% | 31.8% |
| 20× | 28.2% | 32.9% |

Example 3 shows that the encapsulated pulps do not show any significant variations in their precipitation behaviour. This can be seen in the volume proportions of the precipitated capsules.

### Example 4

### Precipitation Behaviour of the Capsules According to the Invention, Dispersed in Water, in Relation to Time and Capsule Concentration

In a cylindrical container, distilled water was added to 4 to 6.5 g of encapsulated mango fruit pulp until it reached 100 ml, and homogenised by shaking. If the container was left standing, after a short time the solution separated into a clear upper water phase and a lower non-transparent phase, in which the capsules were dispersed. Table 2 reflects the height of the lower non-transparent dispersion in relation to time and to concentration of the encapsulated fruit pulp (in percent of the total liquid height).

TABLE 2
Precipitation behaviour of the capsules according to the invention,
dispersed in water, in relation to time and capsule concentration

| | | minutes | | | | | | | | | | | | | | | | | | | | |
|---|---|---|---|---|---|---|---|---|---|---|---|---|---|---|---|---|---|---|---|---|---|---|
| | | 0 | 1 | 2 | 3 | 4 | 5 | 6 | 7 | 8 | 9 | 10 | 11 | 12 | 13 | 14 | 15 | 16 | 17 | 18 | 19 | 20 |
| 4.0 g | Volume | 100 | 81 | 56 | 43 | 38 | 35 | 33 | 32 | 31 | 31 | 31 | 31 | 30 | 30 | 30 | 30 | 30 | 30 | 30 | 30 | 30 |
| puree | of | | | | | | | | | | | | | | | | | | | | | |
| | residue | | | | | | | | | | | | | | | | | | | | | |
| | in % | | | | | | | | | | | | | | | | | | | | | |
| 5.0 g | | 100 | 92 | 85 | 76 | 64 | 56 | 50 | 47 | 45 | 43 | 41 | 40 | 40 | 39 | 39 | 38 | 38 | 38 | 38 | 38 | 37 |
| puree | | | | | | | | | | | | | | | | | | | | | | |
| 6.0 g | | 100 | 96 | 90 | 75 | 63 | 56 | 52 | 50 | 47 | 46 | 44 | 43 | 43 | 42 | 42 | 41 | 41 | 41 | 41 | 41 | 40 |
| puree | | | | | | | | | | | | | | | | | | | | | | |
| 6.5 g | | 100 | 96 | 91 | 88 | 84 | 80 | 77 | 73 | 69 | 65 | 61 | 58 | 55 | 53 | 51 | 50 | 49 | 48 | 47 | 47 | 46 |
| puree | | | | | | | | | | | | | | | | | | | | | | |

Example 4 shows precipitation times of the encapsulated pulp.

### Example 5

In a cylindrical container, distilled water was added to 2.2 g of encapsulated mango fruit pulp until it reached 100 ml, and homogenised by shaking. If the container was left standing, after a short time the solution separated into a clear upper water phase and a lower non-transparent phase, in which the capsules were dispersed. Table 3 reflects the height of the lower non-transparent dispersion in relation to time and to particle size distribution of the encapsulated fruit pulp (in percent of the total liquid height).

TABLE 3
Height of the lower non-transparent dispersion in relation to time and to
particle size distribution of the encapsulated fruit pulp

| Particle Size | | | | | | | | | | | | |
|---|---|---|---|---|---|---|---|---|---|---|---|---|
| Distribution in | | | | | | | | | | | | |
| μm | | | Sedimentation properties | | | | | | | | | |
| d10 | d50 | d90 | 2 min | 4 min | 6 min | 8 min | 10 min | 12 min | 14 min | 16 min | 18 min | 20 min |
| 113.6 | 412.9 | 1194 | 83% | 61% | 47% | 41% | 36% | 33% | 31% | 30% | 29% | 28% |
| 106 | 379 | 1090 | 87% | 67% | 53% | 45% | 40% | 37% | 34% | 33% | 31% | 30% |

d10 d50 and d90 are percentile values (medians), d10 means that 10% by volume of the particles have a diameter which is smaller than the diameter given in the table. D10 etc. have been measured with a Beckmann-Coulter apparatus.

Example 5 shows that smaller capsules precipitate slower.

### Example 6

A two phase beverage according to the invention is obtained by mixing the ingredients in table 4.

TABLE 4

| Ingredient | g/L |
|---|---|
| potassium benzoate | 0.185 |
| inverted sugar (73% dry matter) | 68.500 |
| encapsulated mango puree according to | 50.000 |
| example 2 | |
| mango flavour | 2.000 |
| anhydrous citric acid | 1.580 |
| mineral water (containing the following | 895.000 |
| minerals per litre: | |
| Ca 11.5 Mg 8 K 6.2 Chlorides 13.5 | |
| Nitrates 6.3 Sulfates 8.1 Silica 31.7 | |
| Bicarbonates 71.) | |
| Total | 1017.265 |

The beverage is pasteurized at 62° C. for 20 min while it is stirred with in a traditional agitator with 4 blades. Rotational speed can be varied from 5 to 1038 rpm without changing the properties of the beverage as it is shown in example 7.

The pH of the beverage is 3.38.

### Example 7

Trials have been carried out in order to determine factors influencing film impression perceived when drinking the beverage according to the invention. “Film impression” may be defined as perceived fibers on the teeth, remaining or not, after swallowing the beverage. The trials have been carried out on beverages containing mango puree, inverted sugar (73% dry matter) as sugar added or not added, acid added or not added, hand, high or low shear mixing, adjusted pH values, heat treatment time and temperature. The pH was adjusted to 5.0/4.75/4.5/4.25/4.0/3.75/3.5 with each acid.

TABLE 5

| | FORMULA | | | | | | | | | |
|---|---|---|---|---|---|---|---|---|---|---|
| | % of | | | citric | Lactic | Tartaric | Ascorbic | Malic | | |
| Sample | puree | pH | Preservative | acid | Acid | Acid | Acid | acid | sugar | flavor |
| 1 | 3.5 | 4.5 | no | no | | | | | no | no |
| 2 | 3.5 | 3.5 | yes | yes | | | | | no | no |
| 3 | 3.5 | 3.5 | no | yes | | | | | no | no |
| 4 | 5 | 3.5 | yes | yes | | | | | yes | yes |
| 5 | 2.5 | 3.5 | yes | yes | | | | | yes | yes |
| 6 | 5 | 3.1 | yes | yes | | | | | yes | yes |
| 7 | 5 | 3.1 | yes | yes | | | | | no | yes |
| 8 | 5 | 5.4 | yes | no | | | | | yes | yes |
| 9 | 5 | 3.03 | yes | yes | | | | | yes | yes |
| 10 | 5 | 3.03 | yes | yes | | | | | yes | yes |
| 11 | 5 | 3.03 | yes | yes | | | | | yes | yes |
| 12 | 5 | 3.03 | yes | yes | | | | | yes | yes |
| 13 | 5 | 3.03 | yes | yes | | | | | yes | yes |
| 14 | 5 | 3.03 | yes | yes | | | | | yes | yes |
| 15 | 5 | 3.03 | yes | yes | | | | | yes | yes |
| 16 | 5 | 3.03 | yes | yes | | | | | yes | yes |
| 17 | 3.5 | >4.0 | yes | no | no | no | no | yes | yes | yes |
| 18 | 3.5 | ≦4 | yes | yes | no | no | no | no | yes | yes |
| 19 | 3.5 | >4 | yes | yes | no | no | no | no | yes | yes |
| 20 | 3.5 | ≦4.5 | yes | no | yes | no | no | no | yes | yes |
| 21 | 3.5 | >4.5 | yes | no | yes | no | no | no | yes | yes |
| 22 | 3.5 | ≦4.5 | yes | no | no | yes | no | no | yes | yes |
| 23 | 3.5 | >4.5 | yes | no | no | yes | no | no | yes | yes |
| 24 | 3.5 | ≦5 | yes | no | no | no | yes | no | yes | yes |
| 25 | 3.5 | >5 | Yes | no | no | no | yes | no | yes | yes |

| | | | | | ORGANO- |
|---|---|---|---|---|---|
| | | | | | LEPTIC |
| | | | | | PROPERTIES |
| | HEAT | SHEARING | | | Film |
| Sample | TREATMENT | Hand | Low | high | impression |
| 1 | no | 5 rpm-30 s | | | no |
| 2 | no | 5 rpm-30 s | | | yes |
| 3 | no | 5 rpm-30 s | | | yes |
| 4 | 62° C.-20 mn | 5 rpm-30 s | | | yes |
| 5 | 62° C.-20 mn | 5 rpm-30 s | | | yes |
| 6 | 62° C.-20 mn | 5 rpm-30 s | | | yes |
| 7 | 62° C.-20 mn | 5 rpm-30 s | | | yes |
| 8 | 62° C.-20 mn | 5 rpm-30 s | | | no |
| 9 | 62° C.-20 mn | 5 rpm-30 s | | | yes |
| 10 | 62° C.-20 mn | | 550 rpm-1 mn | | yes |
| 11 | 62° C.-20 mn | | | 550 rpm-1 mn | yes |
| 12 | 62° C.-20 mn | | | 1038 rpm-1 mn | yes |
| 13 | 62° C.-20 mn | | | 1038 rpm-6 mn | yes |
| 14 | 89° C.-10 s | | | | yes |
| 15 | 89° C.-10 s | | 550 rpm-1 mn | | yes |
| 16 | 89° C.-10 s | | | 1038 rpm-1 mn | yes |
| 17 | 90° C.-20 mn | 5 rpm-30 s | | | no |
| 18 | 90° C.-20 mn | 5 rpm-30 s | | | yes |
| 19 | 90° C.-20 mn | 5 rpm-30 s | | | no |
| 20 | 90° C.-20 mn | 5 rpm-30 s | | | yes |
| 21 | 90° C.-20 mn | 5 rpm-30 s | | | no |
| 22 | 90° C.-20 mn | 5 rpm-30 s | | | yes |
| 23 | 90° C.-20 mn | 5 rpm-30 s | | | no |
| 24 | 90° C.-20 mn | 5 rpm-30 s | | | yes |
| 25 | 90° C.-20 mn | 5 rpm-30 s | | | no |

The results of the tests reported in table 5 show that film impression is independent of shearing rate, heat treatment time or temperature, percentage of encapsulated puree, presence of sugar or flavor or preservative. Conversely film impression is linked to pH value. Film impression started at pH:

4.0 for citric acid,

5.0 for ascorbic acid,

4.5 for lactic acid,

4.5 for tartaric acid,

4.0 for malic acid.

For each acid with decreasing of the pH the film impression increased. Therefore a new method to decreasing film forming and film forming sensation in a product corresponding to the invention consists in increasing the pH of the beverage. A new method for completely suppressing film forming and film forming sensation in a product corresponding to the invention consists in increasing the pH of the beverage above 4.0 with citric acid or above 5.0 with ascorbic acid or above 4.5 with lactic acid or above 4.5 with tartaric acid or above 4.0 with malic acid.

### Remark to Examples 8 and 9

Three methods in examples 8 and 9 have been used to quantify the sharpness of the separation between the two phases of a beverage according to the present invention.

### Example 8

The beverage in example 1 was left to settle for two hours at 20° C. in a graduated test tube of 2.5 cm of diameter.

The transition between the 2 phases did not extend beyond 2 graduations; Above the liquid was clear, below it was uniformely turbid.

### Example 9

First method to quantify the sharpness of the separation between the two phases of a beverage according to the present invention: Light absorbance has been measured using a spectrophotometre “800 visible Perkin Elmer”.

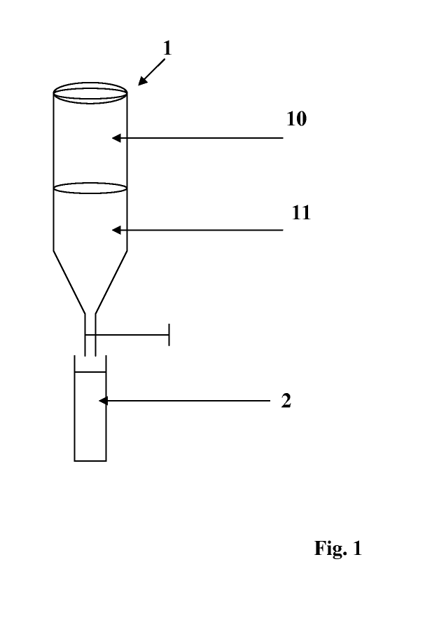

FIG. 1 shows a device for taking ml per ml subsamples of a two-phase beverage according to the invention for the purpose of determining the absorbance of each subsample at 400 nanometers with a 800 UV visible Perkin Elmer spectrophotometre. The sample is poured into a burette (1). After sedimentation the sample has a supernatant phase (10) consisting of clear water and a turbid phase (11). 1 ml subsamples are taken into capsules (2).

The subsampling device represented by FIG. 1 and used in the present example consisted of a burette (1) with a diametre of 2 cm, in which 8 ml of the sample to be tested were poured and were elutriated for 2 hours. A clear upper part (10) consisting of water and a turbid lower part (11) consisting of encapsulated mango puree resulted.

The content of the burette was taken ml per ml into spectrophotometer capsules (2) which were then inserted into a visible spectrophotometer 800 UV of Perkin Elmer. Absorbance measurement at 400 nanometer were repeated 3 times.

Absorbance measurement were also recorded in the same way for pure water on the one hand and for non encapsulated mono-phasic mango puree mixed with water on the other hand.

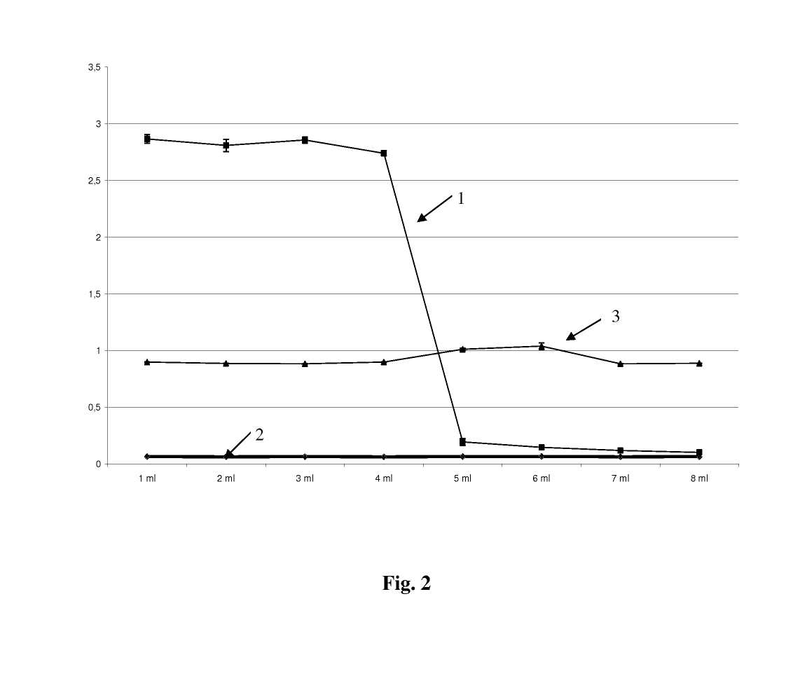

Results represented by FIG. 2 and in table 6 show the sharp difference between the 4 and 5 ml subsamples of the two-phase beverage. There is no significant variation in density neither between the 4 subsamples of the clear upper phase nor between the 4 subsamples of the turbid lower phase. There is almost no difference between the 4 subsamples of the upper clear phase and pure water. There is almost no difference between the eight subsamples of non-encapsulated puree mixed with water.

TABLE 6

| | 1 ml | 2 ml | 3 ml | 4 ml | 5 ml | 6 ml | 7 ml | 8 ml |
|---|---|---|---|---|---|---|---|---|
| absorbance pure | 0.0643 | 0.0612 | 0.0624 | 0.0616 | 0.063 | 0.0642 | 0.061 | 0.0634 |
| water | | | | | | | | |
| absorbance pure | 0.0633 | 0.0622 | 0.0631 | 0.0619 | 0.0633 | 0.0643 | 0.062 | 0.0621 |
| water | | | | | | | | |
| average absorbance | 0.0638 | 0.0617 | 0.06275 | 0.06175 | 0.06315 | 0.06425 | 0.0615 | 0.06275 |
| pure Water | | | | | | | | |
| standard deviation | 0.0007071 | 0.000707 | 0.000495 | 0.000212 | 0.000212 | 0.000707 | 0.000707 | 0.000919 |
| absorbance two- | 2.8205 | 2.7673 | 2.8259 | 2.7136 | 0.2278 | 0.1406 | 0.1181 | 0.0992 |
| phase beverage | | | | | | | | |
| (example 2) 1 | | | | | | | | |
| absorbance two- | 2.8859 | 2.7901 | 2.8636 | 2.7539 | 0.1783 | 0.1528 | 0.1182 | 0.1022 |
| phase beverage | | | | | | | | |
| (example 2) 2 | | | | | | | | |
| absorbance two- | 2.8924 | 2.8691 | 2.8793 | 2.7507 | 0.1707 | 0.1385 | 0.1118 | 0.1001 |
| phase beverage | | | | | | | | |
| (example 2) 3 | | | | | | | | |
| average absorbance | 2.8662667 | 2.808833 | 2.856267 | 2.7394 | 0.192267 | 0.143967 | 0.116033 | 0.1005 |
| two-phase beverage | | | | | | | | |
| (example 2) | | | | | | | | |
| standard deviation | 0.0397681 | 0.053423 | 0.027445 | 0.022401 | 0.031007 | 0.007722 | 0.003667 | 0.001539 |
| absorbance non | 0.8973 | 0.8868 | 0.8812 | 0.8967 | 1.0214 | 1.0721 | 0.8807 | 0.8879 |
| encapsulated puree 1 | | | | | | | | |
| absorbance non | 0.8939 | 0.8841 | 0.8822 | 0.8933 | 1.0053 | 1.0214 | 0.8829 | 0.8854 |
| encapsulated puree 2 | | | | | | | | |
| absorbance non | 0.8982 | 0.8847 | 0.8799 | 0.8997 | 1.0021 | 1.0193 | 0.8814 | 0.8829 |
| encapsulated puree 3 | | | | | | | | |
| average absorbance | 0.8964667 | 0.8852 | 0.8811 | 0.896567 | 1.0096 | 1.0376 | 0.881667 | 0.8854 |
| non encapsulated | | | | | | | | |
| puree | | | | | | | | |
| atandard deviation | 0.0022679 | 0.001418 | 0.001153 | 0.003202 | 0.010344 | 0.029896 | 0.001124 | 0.0025 |

FIG. 2 shows the graphs corresponding to the absorbance values of table 6:
(1): the eight 1 ml subsamples of the two-phase beverage
(2): eight subsamples of pure water
(3): eight subsamples of non encapsulated fruit puree mixed with pure water

What is claimed is:

1. A method for producing encapsulated fruit pulp, comprising:
a) contacting fruit pulp with an encapsulating agent
b) mixing the fruit pulp and the encapsulating agent, thus obtaining a mixture, and
c) adding said mixture to an aqueous solution, which activates capsule formation so that encapsulation occurs,
wherein during encapsulation shear energy is introduced into the aqueous solution in such an amount that the resulting encapsulated fruit pulp does not predominantly form spherical capsules but maintains a fibre-like structure similar to the texture of the fruit pulp itself.

2. The method of claim 1, wherein said encapsulating agent comprises a carbohydrate and/or an alginate.

3. The method of claim 1 wherein said fruit pulp is selected from the group consisting of orange pulp, black currant pulp, pear pulp, mango pulp, kiwi pulp and peach pulp.

4. The method of claim 1, wherein said capsules of the encapsulated fruit pulp have an average diameter, d50, of less than 2 mm, with d50 being the percentile value, in which 50% of the capsules have a smaller diameter than the stated number.

5. An encapsulated fruit pulp, made in accordance with the method of claim 1.

6. A method for the production of compositions containing encapsulated fruit pulp and a liquid, comprising adding the encapsulated fruit pulp of claim 5 to a liquid.

7. A composition comprising the encapsulated fruit pulp of claim 5 and a liquid.

8. The composition of claim 7, further comprising a flavouring substance.

9. The composition of claim 7 wherein said composition is a two-phase beverage.

10. The composition of claim 9, wherein the pH of said two-phase beverage is higher than 4.

11. The method of claim 2 wherein said alginate comprises sodium alginate.

12. The encapsulated fruit pulp of claim 5 wherein said capsules have, on average, a length to breadth ratio of greater than 1.2.

13. The method of claim 6 wherein said encapsulated fruit pulp and liquid comprise a beverage.
